(19) United States
(12) Patent Application Publication
(10) Pub. No.: US 2009/0234926 A1
(43) Pub. Date: Sep. 17, 2009

(54) Using a local business directory to generate messages to consumers

(76) Inventors: Benjamin J. Stern, Morris Township, NJ (US); Narendra Gupta, Dayton, NJ (US)

Correspondence Address: AT & T LEGAL DEPARTMENT - Canavan, ATTN: PATENT DOCKETING, ROOM 2A-207, ONE AT & T WAY, BEDMINSTER, NJ, 07921, US

(21) Appl. No.: 12/075,582

(22) Filed: Mar. 12, 2008

(51) Int. Cl. G06F 15/16

(52) U.S. Cl. 709/206

(57) ABSTRACT

A system and method are provided for notifying a user of a change to a record in a business record directory, based on user specified contact information and preferences. A significance engine determines if identified business record directory changes warrant message generation and delivery to requesting users.

### CROSS REFERENCE TO RELATED APPLICATIONS

This application is related to U.S. application Ser. No. ______ [dkt. 2006-0606], entitled “Finding the Website of a Business Using the Business Name,” by Narendra Gupta et al., filed on the same date as the present application, and is related to U.S. application Ser. No. ______ [dkt. 2006-0646], entitled “Using Web-Mining to Enrich Directory Service Databases and Soliciting Service Subscriptions,” by Narendra Gupta et al., filed on the same date as the present application, the disclosures of which are hereby incorporated by reference herein in their entirety.

### FIELD OF THE INVENTION

The present invention relates generally to a business directory database, and more particularly, to using information from the directory to deliver targeted messages to those requesting such messages when data from the directory changes.

### BACKGROUND OF THE INVENTION

Traditional paper bound business directories have been around since the late 19^{th} century. Folklore has it that a printer working on a regular telephone directory ran out of white paper and used yellow paper instead. The functionality of business directories has remained largely unchanged over the years and still features business names and phone numbers categorized by the types of products and services provided. Current business directories also feature premium listings which may be larger, contain color, include more information than just the basic listing and include sections for public information and coupons.

Business directory websites, such as the YellowPages.com (YPC) website, have brought the basic concept of business directories into the Internet/WWW age while improving ease of use and functionality. The YPC can trace its history to 1996, when an independent publisher and two telecommunications companies (SBC and BellSouth) each launched their own online directories. They continued to operate separately until November 2004, when SBC and BellSouth entered into a partnership to create the internet Yellow Pages joint venture, acquiring the online directory publisher then known as WWW.Yellowpages.com, Inc. The three separate sites were combined into one site called YellowPages.com. YPC offers searchable directory listings, and includes information on Products/Services provided, Specialty, Brands, Payment Options, Languages Spoken, Certification & Affiliation, Coupons & Deals, and User Reviews. Also, when a user registers with YPC, addresses of interest, recent searches and recently viewed listings can be saved for future reference. Additionally, search information, maps and driving directions can be saved, emailed or sent by text message to a device capable of receiving this type of message.

Customers who search business listings directly are typically looking for a particular type of good or service, and are ready to purchase. The traditional bound business directories are by their nature published periodically (typically annually) and therefore not able to be changed once issued. It is very frustrating for consumers to call or worse travel to a listed business location only to find out they are no longer there or have changed their hours, and then have to start their search all over again. This is not a limitation of the YPC, as it is a live business directory database which is updated continuously as business or other conditions change.

Several travel-related businesses have started using their websites to provide messages to their customers or potential customers for products or services they may be interested in purchasing. Each company operates slightly differently, but the general business models are similar. A customer registers with the company's website or downloads a small piece of software to, for example, find the cheapest airline ticket from Philadelphia to Chicago on a particular set of departure/return dates. Depending on the company, an email, message alert or Real Simple Syndication (RSS) feed or similar communication is sent to the customer informing him of the lowest price(s) available or even when a seat is available which meets or is less expensive than a determined price. It is then up to the consumer to decide to purchase or let that opportunity pass. Those systems benefit both the customer and the business. Such price alert systems, however, are highly specialized to function within a travel service database. Alerts are triggered by particular price changes and cannot be triggered by other types of changes. The alerts do not take into consideration the contents of free-text fields.

It would therefore be desirable to provide a message generation and delivery system available to businesses listed in an on-line business directory which would benefit customers by providing a method and system to receive timely, relevant business messages from businesses they are interested in, receive messages only when particular types of significant changes to those businesses are made and receive those messages from a trusted source. Additionally it would be desirable to provide a message generation and delivery system that would benefit the business by targeting customers specifically requesting such messages, and would automate and link messages to significant changes. Such a system would allow businesses to leverage established IT infrastructure and the large user base of directory search businesses.

### SUMMARY OF THE INVENTION

In accordance with one aspect of the invention, a method is provided for notifying a user of a change to a record in a directory. The directory contains a plurality of business records corresponding to businesses, each business record containing data relating to the corresponding business including at least geographic data and business classification data. The data is searchable by a plurality of users. A user profile is received from the user, the profile including user contact information. A change to the business record in the directory is detected. It is determined whether the detected change meets a significance criterion. If so, then a message is generated including information regarding the change, and the message delivered, using the user contact information.

The user profile may further include user preferences identifying types of changes of which the user wishes to be notified. In that case, the method further comprises the step of determining a type of the detected change, and the step of delivering the message further comprises identifying message recipients based at least in part on whether users have user preferences to receive notification of changes of the determined type.

The user profile may further include user preferences identifying products of interest to the user. The method in that case further comprises the step of determining a product to which the detected change relates, and the step of delivering the message further comprises identifying message recipients based at least in part on whether users have user preferences including the determined product.

The user profile may further include user preferences identifying topics of interest to the user. The method then further comprises the step of determining a topic to which the detected change relates, and the step of delivering the message further comprises identifying message recipients based at least in part on whether users have user preferences including the determined topic.

The user profile may further include user preferences identifying business categories of interest to the user. In that case, the method further comprises the step of determining a business category to which the detected change relates, and the step of delivering the message further comprises identifying message recipients based at least in part on whether users have user preferences including the determined business category.

The user profile may include user preferences identifying geographical locations of interest to the user. The method in that case further comprises the step of determining a geographical location to which the detected change relates, and the step of delivering the message further comprises identifying message recipients based at least in part on whether users have user preferences including a the determined geographical location.

The contact information may contain an electronic messaging address, the messages being delivered to electronic messaging addresses.

The change to the business record may include a new coupon. The step of detecting a change may include detecting a field update in a record in the directory. The step of detecting a change may include detecting at least one of a record being added to the directory and a record being deleted from the directory. The step of detecting a change may include generating a change event data set including a pointer to the change in the directory, the original and changed data of the record and a timestamp.

The step of determining whether the detected change meets a significance criterion may include processing the change in a rules-based algorithm, or may include processing the change in a data-driven machine learning algorithm.

The business record may contain a free-form text field. In that case, the step of determining whether the detected change meets a significance criterion may include comparing information elements of a same type in old and new versions of the free-form text. The step may include comparing changes in the free-form text with changes previously determined to be significant.

The step of determining whether the detected change meets a significance criterion may include determining whether a change has occurred in at least one of a restaurant menu, hours of operation, merchandise offered, sale dates and coupons.

The significance criterion may be determined, at least in part, by a business to which a changed record corresponds.

The method may additionally include the step of detecting a change in a Web site of a business, and performing the determining step, the generating step and the delivering step based on a detected change in the business Web site.

Another embodiment of the invention is a computer-usable medium having computer readable instructions stored thereon for execution by a processor to perform a method for notifying a user of a change to a record in a directory. The method includes steps similar to those described above.

These aspects of the invention and further advantages thereof will become apparent to those skilled in the art as the present invention is described with particular reference to the accompanying drawings.

### BRIEF DESCRIPTION OF THE DRAWINGS

FIG. 1 is a functional block diagram embodiment of the system in accordance with an aspect of the present invention; and

FIG. 2 is a flowchart depicting a method in accordance with an aspect of the present invention.

### DESCRIPTION OF THE INVENTION

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The present invention leverages the information in a directory of local business listings (such as the YellowPages.com (“YPC”) database) to provide information on changes in businesses to registered users (customers). Examples of a message delivery service may include, but are not limited to, voice mail (cell or land-line), SMS text message, RSS (Really Simple Syndication) message, e-mail message, fax or regular mail.

The message delivery service allows customers to receive information they have requested from a range of local (and national) businesses, and allows small businesses to leverage YPC's IT infrastructure and registered user database for contacting existing and potential customers. Existing and new customers can register with a service provider such as YPC, and provide contact information by specifying a message delivery method. A user may also specify preferences by specifying one or more locales of interest such as the town in which he or she lives or works. Specified preferences may also include business categories of interest from the directory's index, such as “Restaurants” or “Clothing Stores,” or types of products and services such as “gourmet food.” A type of product or service such as “gourmet food” might, for example, elicit messages from many types of businesses, such as restaurants, wine stores, groceries, cooking schools.

A change detection system monitors the database for significant changes in listings (e.g., new stores, new coupons, change in hours of operation) and automatically notifies registered users, according to their specified contact method, of changes in businesses that match the selected business categories of interest. For example, customers might be notified of a new restaurant in their town, new hours of operation of a local hairdresser, or new on-line coupons at a local clothing store. An enhanced functionality may notify customers of more complex changes, such as a new menu at a local restaurant, or a new doctor at a pediatrician office. These notification events are triggered by normal directory updates, and/or through updates by the businesses specifically for the purpose of generating messages. A further enhanced functionality may detect changes in a businesses' website, similarly determine significance and as appropriate generate and deliver a message.

The inventors believe that all three of the business directory service, the customers and the providers of the goods and services (businesses) featured in an on-line business directory listing will benefit from the targeted message delivery service of this invention, alerting customers of changes to the directory.

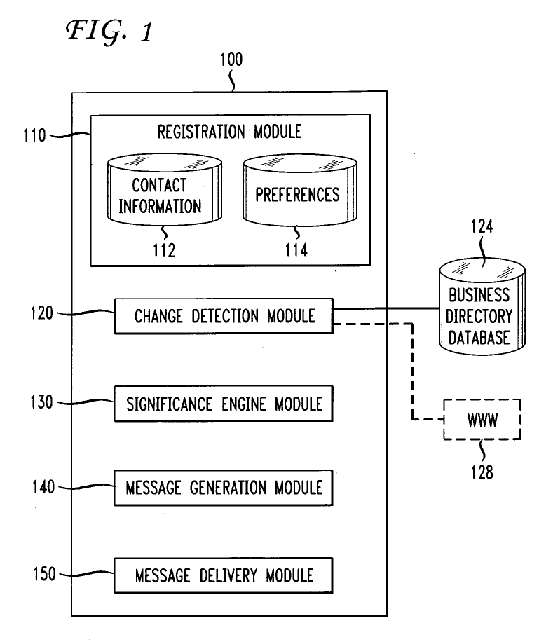

FIG. 1 depicts a functional block diagram illustrating the system 100 of the present invention. The system 100 includes five functions or modules: Registration Module 110, Change Detection Module 120, Significance Engine Module 130, Message Generation Module 140 and Message Delivery Module 150.

The registration module 110 is a database used to build a customer profile by capturing various types of user provided data. Contact information 112 specifies the preferred delivery method(s) for the messages, and may include one or more methods such as, but not limited to, SMS text, Fax, RSS feed, cell voice mail or land-line voice mail. The contact information may further include address information for the included delivery methods.

The customer profile may optionally contain preferences information 114 such as one or more locations of interest, typically the customer's town of residence and/or work, the business categories or product categories of interest selected from the directory's index, and the type(s) of change(s) the customer is interested in, such as “new merchant” or “coupons.” The contact information 112 and the preference information 114 may be stored in a separate database with each entry linked to a particular user. The contact and preference information may alternatively be stored in a single database. An example of locations of interest may be Cambridge, Mass. (work location) and Framingham, Mass. (residence location). Examples of business categories are Japanese Restaurants, Hobby and Model Shops, Motorcycle Dealers or Sporting Goods. Examples of product categories include digital cameras, gourmet food and live music.

The change detection module 120 collects data on changes in the business directory database listings 124. Changes may include the creation, updating or deletion of records in a database. The changes are represented as data, collected by the change detection module 120. The data may have business implications to be interpreted separately by the significance engine 130. For example, two interesting types of change are the creation or addition of a record and the deletion of a record in the business directory database 124. In the change detection module 120, those data events are simply collected. Such a change may or may not mean that a business has opened or closed. Additional examples of changes are the addition of a new coupon (say for a restaurant, hobby shop or sporting goods store), a nail salon moving, a hospital adding a trauma center or a name change at an accounting firm.

Database change reporting is a feature of commercially available directories and database systems such as Oracle® and Microsoft SQL®. A data record is created and associated with each change event, including a pointer to the listing, the names of the changed fields, the old and new contents, and a timestamp. Fields in the business database 124 may include (but are not limited to) the business name, address, phone number, fax number, website, hours of operation, general information, links to coupons, products offered or in stock, etc.

In another embodiment of the invention, the World Wide Web (WWW) 128 is another input to the change detection module 120. In that version of the current invention, businesses' Web pages are regularly scanned for changes. The scan may compare the current web page with a cached copy, update the cache and indicate a change was found. An appropriate algorithm, possibly using natural language processing techniques similar to those discussed below in relation to free-form text fields as part of the significance engine module 130, determines whether a change has occurred and the system behaves much in the same way as if the change originated from a directory update change. An example of a type of change found by web page change scanning could be the addition of a new clothing designer's product line to a clothing store. If a cached copy of the store's web page is compared to the current web page and a change is detected (as in this example the addition of a new designer clothes line), a data change record is created and stored, and provided to the significance engine module 130 for interpretation as to significance as outlined below.

The significance engine module 130 performs an algorithm or a set of operations or instructions on data collected by the change detection module 120. In this context, the significance engine module 130 decides whether or not a change record (data) detected by the change detection module 120 meets certain criteria making it significant enough to merit sending a message. Implied in the significance determination is the consequence than not all changes are significant. Algorithms used in the significance engine may have different bases, including mathematically based (i.e. if a record value is greater than 100, it is significant), rules based (i.e. if a record is new, it is significant) and machine learning-based (trained on examples in which significance has been determined from users). Additional rules-based algorithms could be statistical models of user behavior, and/or other Natural Language Processing techniques. More complex algorithms can be used to analyze free-form text fields, such as the “General Info” field in the business directory database 124. One approach is to search the old and new versions of the text for “information elements,” such as product names, prices, or even category-specific elements, such as menus for restaurants. Change events would be identified as significant if elements of the same type, but with different values, are found in both the new and the old text.

An algorithm may use data provided by the customer as part of his or her preferences 114, as an input to the significance engine module 130. For example, under the category of restaurants, one user may indicate she does not want to know about a new sandwich added to the lunch menu at a local sandwich shop (she always brown-bags lunch at work), while another user does want to know about changes to a lunch menu at the same local sandwich shop (he always goes out for lunch). Therefore in this example, changes that are not significant to the first user (Ms. Brownbag) are significant to the second user (Mr. Sandwich Shop Regular). A result of the difference in significance for each user would then ultimately determine if they were sent a message pertaining to changes on the menu at the local sandwich shop.

The user preferences 114 are treated as input features of the decision-making process performed by the significance engine 130. Other features, however, might also be included in the decision process even if those features are not explicitly added by users as user preferences. For example, the size of the business, or geographic data, might be considered even if not contained in the user preferences. Other factors in addition to those features might also affect the decision, such as logic rules, data from other users' experiences, business rules, etc. Based on features and those other components of the algorithm, a decision is made about significance.

There is therefore not typically a simple if-a-then-b relationship between changes that match a preference and the sending of a message. Instead, the user preferences are features, or conditions, that the significance engine includes in making a decision, and the decision can involve a (possibly complex) rule-based or data-driven combination of these features. For example, it is unlikely that a change in geographical location alone would trigger a message to a user, even if geographical location were listed in the user's preferences. Instead, it is likely that a match of both topic and location, for example, would be required to trigger a message delivery.

The message generation module 140 generates a message and prepares it for delivery. The message includes the necessary contact information 112 (method to use, electronic or physical address, . . . ) and the actual message content. The message generation module 140 may be driven with simple rules or more complex text generation technology. For example, a change in the “hours of operation” field may result in a message that begins with the name of the business, followed by text informing the customer the hours of operation have changed, and listing the new hours.

The message delivery module 150 sends the actual message to the customer, as prepared by the message generation module 140.

The overall system 100 of this invention may be enhanced to give businesses more control over the system. For example, a “Message Event” text field may be added to the business directory database. A database rule may be to generate a message when the “Message Event” text field is updated, with message content taken directly from the content of the text field. This could allow small businesses to leverage the business directory's IT infrastructure and database 124 to contact existing and new customers that have expressed explicit interest, through their preferences, for this business's product or service.

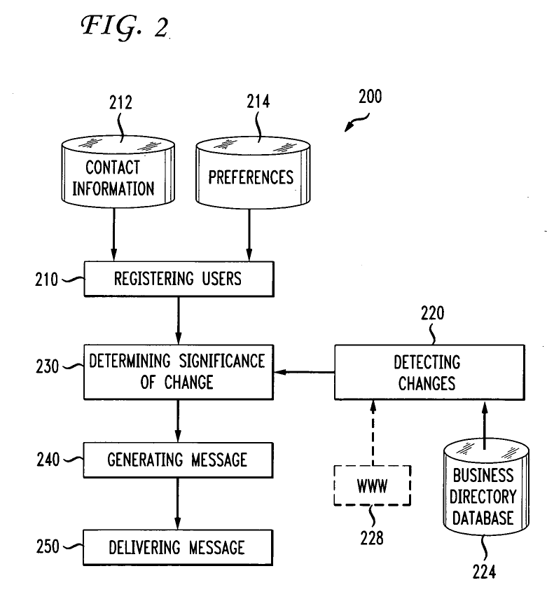

FIG. 2 is a flowchart depicting a method 200 in accordance with an aspect of the present invention. Users register (step 210) with a business directory database regarding the message delivery service with the registration module. Contact information 212 (typically comprising an email address or other preferred contact method) and preference 214 (typically comprising location(s) of interest, business categories of interest and types of changes) are input to the registration module in the registration step 210.

Changes are detected (step 220) by collecting data regarding all changes made to databases that the change detection module interacts with, including but not limited to the business directory database 224 and possibly the World Wide Web (WWW) 228.

Information from both the registration module and the change detection module are used in determining whether a detected change meets a significance criterion (step 230). Using algorithms within the significance engine module and data provided by the registration module and the change detection module, a determination is made regarding whether or not each change satisfies a rule or meets a threshold as to each user.

When a change has been determined to be significant to a particular user, a message is generated (step 240) by the message generation module and delivered (step 250) by the message delivery module.

The invention provides small businesses with a mechanism for contacting local customers with news about changes in their business without having to manage customer lists and email systems. Businesses, particularly small businesses which advertise in bound and on-line business directories, could benefit from a cost effective way to keep in contact with existing customers and find new customers. Developing an in-house message delivery service can be very expensive to develop, deploy and maintain and is typically beyond the expertise and scope of most small businesses. For the business directory provider, there are advertising opportunities for local businesses, and perhaps selling premium listings that give businesses some control over generating messages.

The invention permits the use of the vast YPC database in a targeted bi-directional way creating value for customers, the businesses listed and the YPC in a manner befitting the information age. Customers receive email alerts on business-related information of interest to them, from a single trusted source. Currently the YPC is limited to mainly answer customer's simple queries.

The foregoing detailed description is to be understood as being in every respect illustrative and exemplary, but not restrictive, and the scope of the invention disclosed herein is not to be determined from the description of the invention, but rather from the claims as interpreted according to the full breadth permitted by the patent laws. It is to be understood that various modifications will be implemented by those skilled in the art, without departing from the scope and spirit of the invention.

We claim:

1. A method for notifying a user of a change to a record in a directory, the directory containing a plurality of business records corresponding to businesses, each business record containing data relating to the corresponding business including at least geographic data and business classification data, the data being searchable by a plurality of users, the method comprising:
receiving from the user a user profile, the profile including user contact information;
detecting a change to a business record in the directory;
determining whether the detected change meets a significance criterion;
if the change meets the significance criterion, then generating a message including information regarding the change; and
delivering the message, using the user contact information.

2. The method of claim 1,
wherein the user profile further includes user preferences identifying types of changes of which the user wishes to be notified,
wherein the method further comprises the step of determining a type of the detected change; and
wherein the step of delivering the message further comprises identifying message recipients based at least in part on whether users have user preferences to receive notification of changes of the determined type.

3. The method of claim 1,
wherein the user profile further includes user preferences identifying products of interest to the user,
wherein the method further comprises the step of determining a product to which the detected change relates; and
wherein the step of delivering the message further comprises identifying message recipients based at least in part on whether users have user preferences including the determined product.

4. The method of claim 1,
wherein the user profile further includes user preferences identifying topics of interest to the user,
wherein the method further comprises the step of determining a topic to which the detected change relates; and
wherein the step of delivering the message further comprises identifying message recipients based at least in part on whether users have user preferences including the determined topic.

5. The method of claim 1,
wherein the user profile further includes user preferences identifying business categories of interest to the user,
wherein the method further comprises the step of determining a business category to which the detected change relates; and
wherein the step of delivering the message further comprises identifying message recipients based at least in part on whether users have user preferences including the determined business category.

6. The method of claim 1,
wherein the user profile further includes user preferences identifying geographical locations of interest to the user,
wherein the method further comprises the step of determining a geographical location to which the detected change relates; and
wherein the step of delivering the message further comprises identifying message recipients based at least in part on whether users have user preferences including a the determined geographical location.

7. The method of claim 1, wherein the contact information contains an electronic messaging address and the messages are delivered to electronic messaging addresses.

8. The method of claim 1, wherein the change to the business record includes a new coupon.

9. The method of claim 1, wherein the step of detecting a change includes:
detecting a field update in a record in the directory.

10. The method of claim 1, wherein the step of detecting a change includes:
detecting at least one of a record being added to the directory and a record being deleted from the directory.

11. The method of claim 1, wherein the step of detecting a change includes:
generating a change event data set including a pointer to the change in the directory, the original and changed data of the record and a timestamp.

12. The method of claim 1, wherein the step of determining whether the detected change meets a significance criterion includes:
processing the change in a rules-based algorithm.

13. The method of claim 1, wherein the step of determining whether the detected change meets a significance criterion includes:
processing the change in a data-driven machine learning algorithm.

14. The method of claim 1, wherein the business record contains a free-form text field, and the step of determining whether the detected change meets a significance criterion includes:
comparing information elements of a same type in old and new versions of the free-form text.

15. The method of claim 1, wherein the business record contains a free-form text field, and the step of determining whether the detected change meets a significance criterion includes:
comparing changes in the free-form text with changes previously determined to be significant.

16. The method of claim 1, wherein the step of determining whether the detected change meets a significance criterion includes:
determining whether a change has occurred in at least one of a restaurant menu, hours of operation, merchandise offered, sale dates and coupons.

17. The method of claim 1, wherein the significance criterion is determined, at least in part, by a business to which a changed record corresponds.

18. The method of claim 1, further comprising the step of:
detecting a change in a Web site of a business, and performing the determining step, the generating step and the delivering step based on a detected change in the business Web site.

19. A computer-usable medium having computer readable instructions stored thereon for execution by a processor to perform a method for notifying a user of a change to a record in a directory, the directory containing a plurality of business records corresponding to businesses, each business record containing data relating to the corresponding business including at least geographic data and business classification data, the data being searchable by a plurality of users, the method comprising the steps of:
receiving from the user a user profile, the profile including user contact information;
detecting a change to a business record in the directory;
determining whether the detected change meets a significance criterion;
if the change meets the significance criterion, then generating a message including information regarding the change; and
delivering the message, using the user contact information.

20. The computer useable medium of claim 19, wherein the step of determining whether the detected change meets a significance criterion includes:
processing the change in a data-driven machine learning algorithm.
